(19) United States
(12) Patent Application Publication
(10) Pub. No.: US 2025/0066665 A1
(43) Pub. Date: Feb. 27, 2025

(54) SILICONE QUATERNARY COMPOUNDS FOR CORROSION INHIBITION

(71) Applicant: ChampionX LLC, Sugar Land, TX (US)

(72) Inventor: Jeremy Moloney, Katy, TX (US)

(21) Appl. No.: 18/796,552

(22) Filed: Aug. 7, 2024

Related U.S. Application Data
(60) Provisional application No. 63/520,975, filed on Aug. 22, 2023.

(51) Int. Cl. C09K 17/38; C08G 77/26; C08G 77/388; C09D 5/08; C09D 183/08

(52) U.S. Cl. CPC C09K 17/38; C08G 77/26; C08G 77/388; C09D 5/08; C09D 183/08

(57) ABSTRACT

Corrosion-inhibiting compositions and methods for inhibiting corrosion by contacting a surface in an oil-field system or water system with a composition comprising quaternary siloxane compound corrosion inhibitor are provided. Treated metal containments employing the corrosion-inhibiting compositions and methods are also provided.

### CROSS REFERENCE TO RELATED APPLICATIONS

This application claims priority under 35 U.S.C. § 119 to provisional patent application U.S. Ser. No. 63/520,975, filed Aug. 22, 2023. The provisional patent application is herein incorporated by reference in its entirety.

### TECHNICAL FIELD

The present disclosure relates generally to corrosion-inhibiting compositions and methods for improved corrosion inhibition of metal surfaces in oil and gas application using corrosion-inhibiting composition comprising a quaternary siloxane compound to replace conventional corrosion inhibitors. The present disclosure is particularly effective with corrosion inhibition in oxygen, carbon dioxide and/or hydrogen sulfide containing environments.

### BACKGROUND

Corrosion remains a significant challenge in the oil and gas industry and are most often caused by salts and/or other dissolved solids, liquids, or gases that cause, accelerate, or promote corrosion of surfaces such as metal surfaces. Controlling internal corrosion is a key problem encountered in flowlines and pipelines along with other infrastructure made from metal, namely carbon steel. Examples of corrodents include carbon dioxide, oxygen, sodium chloride, calcium chloride, and sulfur dioxide. Corrosion negatively impacts metal containments such as metal pipelines, tanks, and/or other metal equipment or devices that contact aqueous liquid sources before, during, or after injection or production.

Most operators in the oil and gas extraction and processing industry employ corrosion inhibitors to reduce internal corrosion in metal containments which are contacted by aqueous liquids containing corrodents. Corrodents are found in injectates, produced water, connate (native water present in subterranean formations along with the hydrocarbon), and hydrocarbon liquids and solids. Corrosion inhibitors are added to the liquids and dissolved gases which come into contact with metal surfaces where they act to prevent, retard, delay, reverse, and/or otherwise inhibit the corrosion of metal surfaces such as carbon-steel metal surfaces. Corrosion inhibitors can include, for example, aliphatic and aromatic amines, amine salts of acids, heterocyclic amines, alkenyl succinic acid, triazoles, and the like.

Corrosion inhibitors are beneficial in that they extend the lifespan of metal surfaces, as well as permit the use of carbon steel components rather than more expensive metals, such as nickel, cobalt, and chromium alloys or other materials more expensive than carbon steel and/or which inherently entail other disadvantages in suitability for the purpose of liquid or gas containment.

Quaternary ammonium compounds, such as dimethyl benzyl ammonium chloride, are commonly used as corrosion inhibitors for the oil and gas industry. However, they have limitations of reduced performance at higher temperatures as well as common SDS hazards including environmental hazards, physical and health hazards, and corrosivity.

Accordingly, it is an object of this disclosure to provide corrosion-inhibiting composition comprising quaternary siloxane compounds and methods for corrosion inhibition of metal surfaces that improve beyond the corrosion inhibition capability of or decrease dosing rates compared to existing corrosion inhibitors, in particular for improved thermal stability to permit higher temperature applications, which are known industry challenges.

It is a particular object of the disclosure to provide corrosion-inhibiting composition comprising quaternary siloxane compounds to provide improved chemical safety and improved SDS hazard profiles and/or improved environmental profiles compare to dimethyl benzyl ammonium chloride.

It is a still further object of the disclosure to provide corrosion-inhibiting compositions particularly suitable for challenging environments including oxygen, carbon dioxide and/or hydrogen sulfide containing environments.

Other objects, embodiments advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is an object, feature, and/or advantage of the present disclosure to provide compositions and methods for inhibiting corrosion in oilfield systems, namely pipelines and other infrastructure.

According to some aspects of the present disclosure, corrosion-inhibiting compositions comprise a quaternary siloxane compound having the general formula:

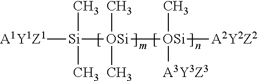

wherein:
Z¹, Z², and Z³ are independently N⁺R⁴R⁵R⁶X⁻ or absent, wherein: R⁴ and R⁵ are independently C1-20 alkyl or hydroxyalkyl groups, and R⁶ is a C1-20 alkyl, aminoalkyl, hydroxyalkyl, or amino hydroxyalkyl group; X⁻ is an anion, such as fluoride, chloride, bromide, iodide, nitrate, or nitrite;
Y¹, Y² and, Y³ are independently C1-20 alkyl, hydroxyalkyl, or absent;
A¹, A², and A³ are independently a Si(CH₃)₃, an OSi(CH₃)₃, a methyl or (CH₂)ₚ—O, wherein p is from 1 to 100;
m is from 1 to 2,000; and
n is 1 to 150,
a solvent, and
at least one additional component selected from the group consisting of additional corrosion inhibitors, surfactants, polymers, pH modifiers, asphaltene inhibitors, paraffin inhibitors, scale inhibitors, metal complexing agents, emulsifiers, water clarifiers, dispersants, emulsion breakers and combinations thereof.

According to additional aspects of the present disclosure, methods of inhibiting corrosion on a surface comprising: providing a corrosive inhibiting effective amount of a corrosion inhibition composition as described according to embodiments herein into contact with a surface comprising metal and is in an oil-and-gas system or waste system, and wherein the contacting is added in a batch or continuous application, and reducing corrosion on the surface.

According to additional aspects of the present disclosure, treated metal containments comprising: a metal containment comprising a metal surface; and a barrier or film substantially coating the metal surface with a corrosive inhibiting effective amount of the quaternary siloxane compound as described according to embodiments herein.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### DETAILED DESCRIPTION

The present disclosure is not to be limited to that described herein, which can vary and are understood by skilled artisans. No features shown or described are essential to permit basic operation of the present disclosure unless otherwise indicated. It has beneficially been found that various corrosion-inhibiting composition comprising quaternary siloxane compounds provide effective corrosion inhibition while also providing additional benefits, e.g. decrease dosing rates compared to existing corrosion inhibitors, improved thermal stability to permit higher temperature applications, improved chemical safety and improved SDS hazard profiles, and/or more environmentally acceptable compositions.

### Definitions

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The terms “comprise(s)”, “include(s)”, “having”, “has”, “can”, “contain(s)”, and variants thereof, as used herein, are intended to be open-ended transitional phrases, terms, or words that do not preclude the possibility of additional acts or structures. The singular forms “a”, “and”, and “the” include plural references unless the context clearly dictates otherwise. The present disclosure also contemplates other embodiments “comprising”, “consisting of” and “consisting essentially of”, the embodiments or elements presented herein, whether explicitly set forth or not.

The methods of the present disclosure may comprise, consist essentially of, or consist of the components and ingredients of the present disclosure as well as other ingredients described herein. As used herein, “consisting essentially of” means that the methods may include additional steps, components or ingredients, but only if the additional steps, components or ingredients do not materially alter the basic and novel characteristics of the claimed methods.

Unless defined otherwise, all technical and scientific terms used above have the same meaning as commonly understood by one of ordinary skill in the art to which embodiments of the present disclosure pertain.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to linear or branched hydrocarbon radical, preferably having 1 to 32 carbon atoms (i.e., 1, 2, 3, 4, 5, 6, 7, 8, 9, 10, 11, 12, 13, 14, 15, 16, 17, 18, 19, 20, 21, 22, 23, 24, 25, 26, 27, 28, 39, 30, 31, or 32 carbons). Alkyls can include straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Commonly used alkyl groups include, but are not limited to, methyl, ethyl, n-propyl, isopropyl, n-butyl, iso-butyl, secondary-butyl, and tertiary-butyl.

Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are commonly used aryls. The term “aryl” also includes heteroaryl.

“Arylalkyl” means an aryl group attached to the parent molecule through an alkylene group. In some embodiments the number of carbon atoms in the aryl group and the alkylene group is selected such that there is a total of about 6 to about 18 carbon atoms in the arylalkyl group. A commonly used arylalkyl group is benzyl.

As used herein, the term “containment” or “metal containment” includes any metal surface or portion thereof that is in contact with liquids in an oil-field system containing corrodent(s). In embodiments the containment is in fluid communication with one or more devices or apparatuses, including other containments. In embodiments the containment is a pipe. In embodiments the containment is a tank. In embodiments, the metal is steel. In embodiments, the steel is carbon steel. In embodiments, the carbon steel is stainless steel.

As used herein, the term “corrodent” refers to one or more salts and/or other dissolved solids, liquids, or gasses that cause, accelerate, or promote corrosion. Non-limiting examples of corrodents are oxygen, hydrogen sulfide, hydrogen chloride, carbon dioxide, sodium chloride, calcium chloride, sulfur dioxide, and combinations thereof. In exemplary embodiments, corrodents are capable of corroding a carbon steel at a rate of at least about 100 milli-inches per year (mpy).

The term “-ene” as used as a suffix as part of another group denotes a bivalent substituent in which a hydrogen atom is removed from each of two terminal carbons of the group, or if the group is cyclic, from each of two different carbon atoms in the ring. For example, alkylene denotes a bivalent alkyl group such as methylene (—CH₂—) or ethylene (—CH₂CH₂—), and arylene denotes a bivalent aryl group such as o-phenylene, m-phenylene, or p-phenylene.

As used herein, the term “exemplary” refers to an example, an instance, or an illustration, and does not indicate a most preferred embodiment unless otherwise stated.

The term “generally” encompasses both “about” and “substantially.”

The term “inhibiting” as referred to herein includes both inhibiting and preventing corrosion on a surface or within a system, namely an oil-field system.

As used herein, the term “optional” or “optionally” means that the subsequently described component, event or circumstance may but need not be present or occur. The description therefore discloses and includes instances in which the event or circumstance occurs and instances in which it does not, or instances in which the described component is present and instances in which it is not.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof.

Furthermore, unless otherwise specifically limited, the term “polymer” shall include all possible geometrical configurations of the molecule.

As used herein, the term “produced water” means a water source that flows from a subterranean formation in a hydrocarbon recovery process such as hydraulic fracturing or tertiary oil recovery, further wherein the water source includes one or more hydrocarbons, one or more dissolved solids, or a combination thereof.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “substituted” as in “substituted aryl,” “substituted alkyl,” and the like, means that in the group in question (i.e., the alkyl, aryl or other group that follows the term), at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like. Further, an alkylene group in the chain can be replaced with an ether, an amine, an amide, a carbonyl, an ester, a cycloalkyl, or a heterocyclo functional group. When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

As used herein, the term “substantially free” refers to compositions completely lacking the component or having such a small amount of the component that the component does not affect the performance of the composition. The component may be present as an impurity or as a contaminant and shall be less than 0.5 wt-%, or in a preferred embodiment is less than 0.1 wt-%, or in a further preferred embodiment is less than 0.01 wt-%.

The term “surfactant” or “surface active agent” refers to an organic chemical that when added to a liquid changes the properties of that liquid at a surface.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Corrosion-Inhibiting Compositions

The corrosion-inhibiting compositions comprise, consist of, or consist essentially of a quaternary siloxane compound, a solvent, and at least one additional component. In some embodiments, the corrosion-inhibiting compositions comprise, consist of, or consist essentially of a quaternary siloxane compound, a solvent, and at least one additional component selected from the group consisting of additional corrosion inhibitors, surfactants, polymers, pH modifiers, asphaltene inhibitors, paraffin inhibitors, scale inhibitors, metal complexing agents, emulsifiers, water clarifiers, dispersants, emulsion breakers and combinations thereof.

### Quaternary Siloxanes

The corrosion-inhibiting compositions include a quaternary siloxane compound. The quaternary siloxane compound refers to a compound containing a backbone of Si—O—Si bonds, wherein the silicon atoms in the backbone are connected to alkyl groups via Si—C bonds except at the chain ends and branching points where the silicon atoms may be connected to either carbon or other atoms such as oxygen, nitrogen, sulfur, and the like.

The quaternary siloxane compound may have the general formula:

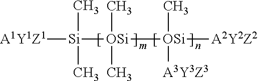

wherein:
Z¹, Z², and Z³ are independently N⁺R⁴R⁵R⁶X⁻ or absent, wherein: R⁴ and R⁵ are independently C1-20 alkyl or hydroxyalkyl groups, and R⁶ is a C1-20 alkyl, aminoalkyl, hydroxyalkyl, or amino hydroxyalkyl group; X⁻ is an anion, such as fluoride, chloride, bromide, iodide, nitrate, or nitrite;
Y¹, Y² and, Y³ are independently C1-20 alkyl, hydroxyalkyl, or absent;
A¹, A², and A³ are independently a Si(CH₃)₃, an OSi(CH₃)₃, a methyl or (CH₂)ₚ—O, wherein p is from 1 to 100;
m is from 1 to 2,000; and
n is 1 to 150.

The quaternary siloxane compounds may have about 2% to about 80%, about 5% to about 8%, about 10%, about 15%, about 20%, about 25%, about 30%, about 35%, about 40%, about 45%, about 50%, about 55%, about 60%, about 65%, about 70%, about 75%, or about 80% of silicone in the compound (percentages shown in wt-%). Beneficially, the siloxane structure provides thermostability to the quaternary siloxane compound and the corrosion-inhibiting compositions. Thermostability as referred to herein for the quaternary siloxane compound and the corrosion-inhibiting composition is the ability of the quaternary siloxane compound to maintain its structural integrity and physical properties along with its functional properties when exposed to high temperatures up to 100° C. Thermostability can be measured by analytical techniques including Fourier-transform infrared spectroscopy (FTIR) or liquid chromatography-mass spectrometry (LCMS) which techniques are well known to those of ordinary skill in the art.

The molecular weight ranges of the quaternary siloxane compounds may be in the range of from about 1,000 to about 150,000. In some exemplary embodiments, the molecular weights of the quaternary siloxane compounds may range from about 1,500 to about 50,000 g/mol.

In some embodiments the ratio of the molecular weights of the silicone/siloxane groups to the quaternary ammonium groups in the quaternary siloxane compound is greater than about 1.5:1, preferably greater than about 2:1, and most preferably greater than about 4:1.

The quaternary ammonium group(s) may be present on the siloxane groups or at the chain ends. The number of quaternary groups per chain of the quaternary siloxane compound may range from 1 to 150. Preferably, there are at least two quaternary groups in the quaternary siloxane compound.

Exemplary quaternary ammonium groups may comprise dialkyl methyl quaternary ammonium groups. The alkyl group of the dialkyl methyl quaternary ammonium groups may contain from about 1 to about 20 carbons. Another example of a suitable quaternary ammonium group comprises two hydroxyalkyl groups and a methyl group. Examples of suitable hydroxyalkyl groups include hydroxyethyl and hydroxypropyl groups. One such example is SILQUAT 0283A silicone quat, an experimental product from Siltech Corporation which contains methyl dihydroxyethyl quaternary ammonium groups. Another example of suitable quaternary ammonium group comprises amide in one or more of the substituents on the quaternary nitrogen atom.

While a variety of quaternary siloxane compounds may be suitable for use with the compositions and methods described herein, exemplary embodiments of the quaternary siloxane compounds may comprise silicone dialkyl quaternary compounds or silicone polyether fatty acid quaternary compounds.

In one embodiment, the quaternary siloxane compound comprises a silicone dialkyl quaternary compound. Exemplary silicone dialkyl quaternary compounds are commercially available from Siltech Corporation, Toronto, Ontario, Canada, including SILQUAT Di-25 silicone quat, SILQUAT J208-1B silicone quat, SILQUAT CR 4000 silicone quat, SILQUAT J15 silicone quat, SILQUAT Di-10 silicone quat, SILQUAT J2-2B silicone quat, SILQUAT J2-8B silicone quat, and SILQUAT C18 silicone quat.

In some embodiments silicone dialkyl quaternary compounds have the general formula:

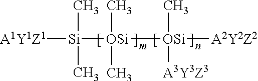

wherein:
Z¹ and Z² are absent, and Z³ is N⁺R⁴R⁵R⁶X⁻, wherein R⁴ and R⁵ are independently C1-20 alkyl or hydroxyalkyl groups, and R⁶ is a C1-20 alkyl, aminoalkyl, hydroxyalkyl, or amino hydroxyalkyl group, and wherein X⁻ is an anion;
Y¹ and Y² are absent, and Y³ is C1-C20 hydroxyalkyl, preferably a C3 hydroxyalkyl; and
A¹ is a methyl, A² is Si(CH₃)₃, and A³ is (CH₂)ₚ—O, wherein p is 1 to 100, preferably 1 to 10, or more preferably 3.

An exemplary silicone dialkyl quaternary compound has the general formula as shown in Structure I:

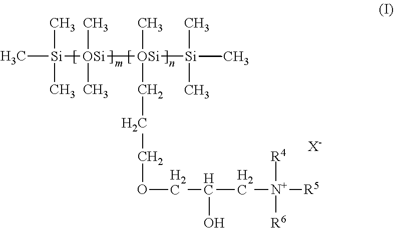

wherein:
R⁴, R⁵, and R⁶ are independently C1-20 alkyl or hydroxyalkyl groups;
X⁻ is an anion;
m is from 1 to 2,000; and
n is 1 to 150.

A further exemplary silicone dialkyl quaternary compound has the general formula as shown in Structure II:

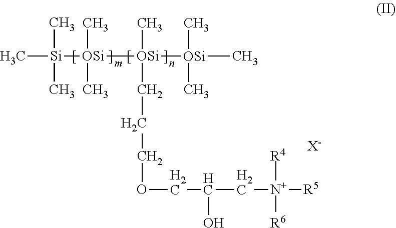

wherein:
R⁴, R⁵, and R⁶ are independently C1-20 alkyl or hydroxyalkyl groups;
X⁻ is an anion;
m is from 1 to 2,000; and
n is 1 to 150.

A further exemplary silicone dialkyl quaternary compound has the general formula as shown in Structure III:

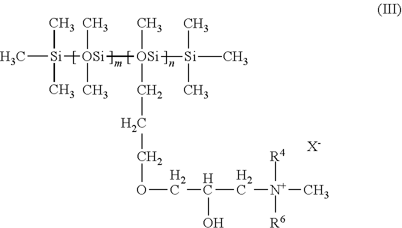

wherein:
R⁴ and R⁶ are independently C1-20 alkyl or hydroxyalkyl groups;
X⁻ is an anion;
m is from 1 to 2,000; and
n is 1 to 150.

A further exemplary silicone dialkyl quaternary compound has the general formula as shown in Structure IV:

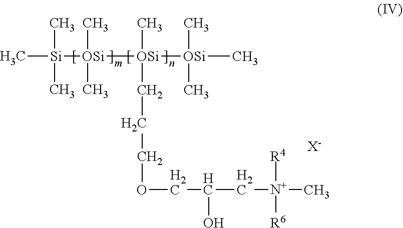

wherein:
R⁴ and R⁶ are independently C1-20 alkyl or hydroxyalkyl groups;
X⁻ is an anion;
m is from 1 to 2,000; and
n is 1 to 150.

Further exemplary silicone dialkyl quaternary compounds have the general formula as shown in Structure V:

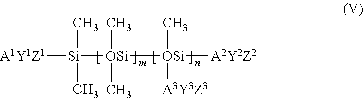

wherein:
Z¹ and Z² are N⁺R⁴R⁵R⁶X⁻, wherein R⁴ and R⁵ are independently C1-20 alkyl or hydroxyalkyl groups, and R⁶ is a C1-20 alkyl, aminoalkyl, hydroxyalkyl, or amino hydroxyalkyl group, and X⁻ is an anion, wherein Z³ is absent;
Y¹ and Y² are C1-C20 hydroxyalkyl, preferably a C3 hydroxyalkyl, and Y³ is absent; A¹ and
A² are (CH₂)ₚ—O, wherein p is 1 to 100, preferably 1 to 10, or preferably 3, and A³ is methyl;
m is from 1 to 2,000; and
n is 1 to 150.

Further exemplary silicone dialkyl quaternary compounds have the general formula as shown in Structure VI:

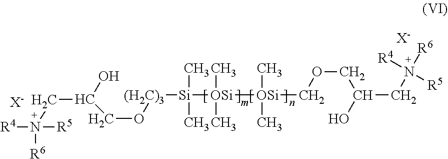

wherein:
R⁴, R⁵, and R⁶ are independently C1-20 alkyl or hydroxyalkyl groups;
X⁻ is an anion;
m is from 1 to 2,000; and
n is 1 to 150.

Further exemplary silicone dialkyl quaternary compound may have the general formula of Structure VII (wherein R⁶ is a methyl) as shown:

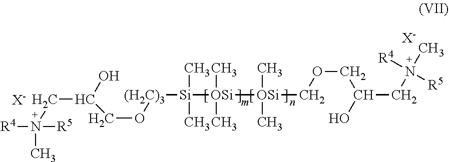

wherein:
R⁴ and R⁵ are independently C1-20 alkyl or hydroxyalkyl groups;
X⁻ is an anion;
m is from 1 to 2,000; and
n is 1 to 150.

In another embodiment, the quaternary siloxane compound comprises a silicone polyether fatty acid quaternary compound. Exemplary a silicone polyether fatty acid quaternary compounds are commercially available from Siltech Corporation, Toronto, Ontario, Canada, including SILQUAT AD silicone quat, and SILQUAT AC silicone quat.

Silicone polyether fatty acid quaternary compounds may have the general formula of Structure V:

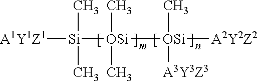

wherein:
Z¹ and Z² are absent, and Z³ is N⁺R⁴R⁵R⁶X⁻, wherein R⁴ and R⁵ are independently C1-20 alkyl or hydroxyalkyl groups, and R⁶ is a C1-20 alkyl, aminoalkyl, hydroxyalkyl, or amino hydroxyalkyl group, and X⁻ is an anion;
Y¹ and Y² are absent, and Y³ is C1-C20 hydroxyalkyl, preferably a C3 hydroxyalkyl; and
A¹ is a methyl, A² is OSi(CH₃)₃, and A³ is (CH₂)ₚ—O, wherein p is 1 to 100, preferably 1 to 10, or preferably 7.

By way of example, the silicone polyether fatty acid quaternary compound may have the following Structure VIII or IX:

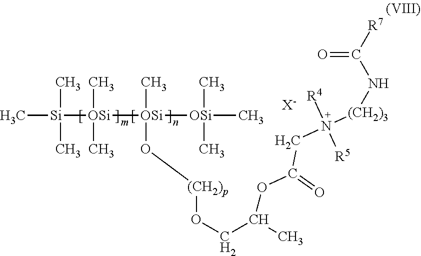

wherein:
R⁴ and R⁵ are independently C1-20 alkyl or hydroxyalkyl groups;
R⁷ is a C1-20 alkyl or hydroxyalkyl group;
X⁻ is an anion;
m is from 1 to 2,000;
n is 1 to 150; and
o is 1 to 100, or

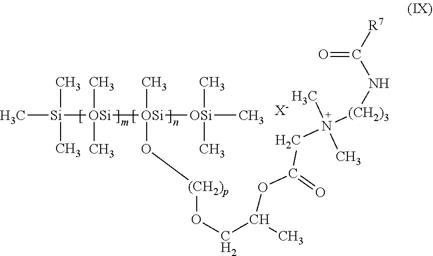

wherein:
R⁷ is independently C1-20 alkyl or hydroxyalkyl groups;
X⁻ is an anion;
m is from 1 to 2,000;
n is 1 to 150; and
o is 1 to 100.

Various commercially-available cationic polydimethylsiloxanes from Siltech Corporation are generally provided as about 70% by weight active solutions of the cationic polydimethylsiloxane in hexylene glycol, dipropylene glycol, or isopropyl alcohol, or they may be completely solvent free. The solubility of the polymers in water or organic solvents is generally determined by the number of branching, chain length, polar groups, for example hydroxyl, ester or ether groups on the pendant or chain end groups, and the functional groups attached to the quaternary ammonium nitrogen.

In some embodiments, the quaternary siloxane compound is included in a composition at an amount of at least about 5 wt-% to about 80 wt-%, about 5 wt-% to about 70 wt-%, about 5 wt-% to about 60 wt-%, or about 5 wt-% to about 50 wt-%. In addition, without being limited according to the disclosure, all ranges recited are inclusive of the numbers defining the range and include each integer within the defined range.

The compositions including the quaternary siloxane compounds are distinct from conventional quaternary ammonium compounds. In preferred embodiments the compositions are substantially free of thiazine quaternary ammonium compounds and silated quaternary ammonium compounds (e.g. quaternary organosilanes including those commonly in monomer form with linkers to allow binding and polymerization to surfaces).

### Solvent

The corrosion-inhibiting compositions can be combined with or delivered with a solvent. In some embodiments more than one solvent is included in the compositions. An exemplary solvent is water, an organic solvent and/or aromatic solvent. An exemplary solvent is water.

Further exemplary organic solvents can include an alcohol, a hydrocarbon, a ketone, an ether, an alkylene glycol, a glycol ether, an amide, a nitrile, a sulfoxide, an ester, or a combination thereof. Examples of suitable organic solvents include, but are not limited to, methanol, ethanol, propanol, isopropanol, butanol, 2-ethylhexanol, hexanol, octanol, decanol, 2-butoxyethanol, glycols and derivatives (ethylene glycol, methylene glycol, 1,2-propylene glycol, 1,3-propylene glycol, diethyleneglycol monomethyl ether, ethylene glycol monobutyl ether, ethylene glycol dibutyl ether, etc.), pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof.

In some embodiments, an alcohol solvent is used, including straight chain or branched aliphatic such as methanol, ethanol, propanol, isopropanol, butanol, 2-ethylhexanol, hexanol, octanol, decanol, 2-butoxyethanol, etc.

In some embodiments, the composition comprises one or more solvents selected from the group consisting of isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, or any combination thereof.

Exemplary aromatic solvents comprise aromatic hydrocarbons such as toluene, xylene, heavy aromatic naphtha, or a combination thereof. Preferably, the aromatic solvent comprises heavy aromatic naphtha or xylene. In any of the embodiments described the aromatic solvent(s) is preferably combined with water.

In some embodiments, the solvent(s) is included in a composition at an amount of at least about 20 wt-% to about 90 wt-%, about 30 wt-% to about 90 wt-%, about 40 wt-% to about 80 wt-%, about 45 wt-% to about 80 wt-%, or about 50 wt-% to about 80 wt-%. In addition, without being limited according to the disclosure, all ranges recited are inclusive of the numbers defining the range and include each integer within the defined range.

### Additional Functional Ingredients

The corrosion-inhibiting compositions can include various additional functional components suitable for uses disclosed herein. In some embodiments, the compositions including the quaternary siloxane compound and solvent make up a large amount, or even substantially all of the total weight of the compositions. For example, in some embodiments few or no additional functional ingredients are disposed therein.

In preferred embodiments no curing agents are required for the quaternary siloxane compounds or corrosion-inhibiting compositions. This is a benefit to the quaternary siloxane compounds and corrosion-inhibiting compositions to exclude a curing agent that is often required for siloxane chemicals to initiate or accelerate cross-linking processes, e.g. to transform them from a liquid or malleable state into a solid or elastomeric state. Exemplary curing agents include for example amines, catalysts (platinum based, tin based), and peroxides.

In other embodiments, additional functional ingredients may be included in the compositions. The functional ingredients provide desired properties and functionalities to the compositions. For the purpose of this application, the term “functional ingredient” includes a material that when dispersed or dissolved in the use and/or concentrate compositions described herein provides a beneficial property in a particular use.

In some embodiments, at least one additional component selected from the group consisting of additional corrosion inhibitors, surfactants, polymers, pH modifiers, asphaltene inhibitors, paraffin inhibitors, scale inhibitors, metal complexing agents (also referred to as chelants), emulsifiers, water clarifiers, dispersants, emulsion breakers and combinations thereof is included in the corrosion-inhibiting compositions.

In embodiments, the additional component may include synergist, additional corrosion inhibitors, solvents, pH modifiers, surfactants, hydrate inhibitors, scale inhibitors, biocides, salt substitutes, relative permeability modifiers, sulfide scavengers, breakers, asphaltene inhibitors, paraffin inhibitors, metal complexing agents (also referred to as chelants), emulsifiers, demulsifiers, iron control agents, friction reducers, drag reducing agents, flow improvers, viscosity reducers, and the like. Exemplary types of the various additional functional ingredients is included in U.S. Pat. No. 11,242,480, which is incorporated by reference in its disclosure of the various listings of additional functional ingredients.

In an exemplary embodiment, the additional component is one or more of an imidazoline compound, a pyridinium compound, a quaternary ammonium compound, a phosphate ester, an amine, an amide, a carboxylic acid, a thiol, or any combination thereof.

According to embodiments of the disclosure, the combination of any additional functional ingredients may be provided in a composition in the amount from about 0 wt-% and about 90 wt-%, from about 1 wt-% and about 90 wt-%, from about 5 wt-% and about 90 wt-%, or from about 10 wt-% and about 90 wt-%. In addition, without being limited according to the disclosure, all ranges recited are inclusive of the numbers defining the range and include each integer within the defined range.

Typically, the compositions are stable to ambient conditions. In some embodiments, the composition is stable at room temperature for at least 6 months, when stored in a sealed container. For example, the composition can be stable at room temperature for at least 9 months, e.g., at least 12 months, at least 18 months, or at least 24 months, when stored in a sealed container. As used herein, the phrase “sealed container” refers to a container constructed of compatible materials (e.g., glass or non-gas permeable plastic) that has been sealed shut. The sealed container can be any non-gas permeable container, where water or volatile materials cannot escape when sealed with a lid that limits evaporation. The non-gas permeable container also limits O₂ or CO₂ ingress into the composition at storage temperatures. Typical examples would be glass jars or bottles with tight-sealing lids, or non-gas permeable plastic bottles with tight-sealing lids.

### Sulfur-Containing Species

The corrosion-inhibiting compositions can include a sulfur-containing species, which are often referred to as synergists. An exemplary synergist class includes mercaptan corrosion inhibitors. Mercaptans are a type of organic thiol molecules and can create a stronger passivation layer on the metal surface to increase persistency of the protective film for corrosion inhibition. In most examples, the sulfur based component consists of a primary thio/mercaptan (e.g., 2-mercaptoethanol or mercaptoacetic acid). Mercaptans are a type of organic sulfur compounds, which include mercaptoalkyl alcohol, mercaptoacetic acid, tert-butyl mercaptan, or a combination thereof. A preferred synergist is a mercaptoalkyl alcohol comprising 2-mercaptoethanol.

Additional exemplary synergist class includes amines such as thiol-amines as disclosed in U.S. Pat. No. 11,242,480, which is incorporated herein by reference in its entirety. These thiol-amines include a class of anti-corrosion compounds having the formula:

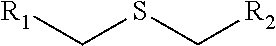

wherein: each R₁ is independently CH₂OH and —C(O)OH; and R₂ is

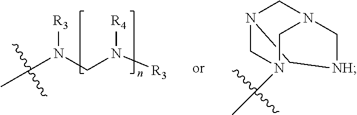

Each R₃ is independently hydrogen or R₅, or both R₃ together form a ring via linker having the formula

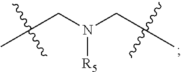

Each R₄ is independently hydrogen or R₅; R₅ is —CH₂SC₂H₅R₁; and n is an integer from 0 to 3.

In some embodiments, the synergist is included in a composition at an amount of at least about 0.1 wt-% to about 20 wt-%, about 1 wt-% to about 20 wt-%, about 5 wt-% to about 20 wt-%, about 5 wt-% to about 15 wt-%, about 1 wt-% to about 10 wt-%, or about 5 wt-% to about 10 wt-%. In addition, without being limited according to the disclosure, all ranges recited are inclusive of the numbers defining the range and include each integer within the defined range.

### Methods of Use

The corrosion-inhibiting compositions are provided to a system in need of effective corrosion control. The methods are suitable for controlling both general and localized corrosion. The methods are further suitable for inhibiting corrosion in challenging environments including oxygen, carbon dioxide and/or hydrogen sulfide containing environments. In particular embodiments, the methods are particularly well suited for inhibiting corrosion in environments that include carbon dioxide and/or hydrogen sulfide, which is more challenging that only oxygenated systems.

The corrosion-inhibiting compositions can be provided in a single composition to an oil-field system or a water system or can be combined with other components, such as solvents and additional functional components (e.g. additional corrosion inhibitors), and the like. In referring to compositions, the scope of the methods of use disclosure also includes combining more than one input (i.e. composition) for the treatment of an oil-field system or a water system.

The methods of use include adding a corrosive inhibiting effective amount of the quaternary siloxane compound or the corrosion-inhibiting composition comprising the quaternary siloxane compound to an oil-field system or water system having at least one surface and inhibiting corrosion of the at least one surface. Beneficially, the composition reduces corrosion of a surface compared to a corrosive environment that does not contain the quaternary siloxane compound corrosion inhibitor. In embodiments, the corrosion reduction (i.e. inhibition efficiency or the percentage of protection afforded) is at least about 60%, at least about 65%, at least about 70%, at least about 75%, or at least about 80% for a surface comprising metal.

The methods apply the quaternary siloxane compound or the corrosion-inhibiting composition comprising the quaternary siloxane compound to a system in need of preventing, reducing or mitigating corrosion. Beneficially, for the corrosion inhibition both localized and generalized corrosion are reduced, as measured by mils penetration per year or milli-inch (one thousandth of an inch) (MPY). MPY is used as an estimated general corrosion rate. The MPY is calculated from the following equation:

$$MPY = ( Δ M [ g ] \cdot C ) / ( ρ [ \frac{g}{{cm}^{2}} ] \cdot A [ {in}^{2} ] \cdot t [ hr ] )$$

where ΔM is the mass loss of the coupon at the end of the test in grams, C is a constant equal to 534000, p is the density of the coupon in g/cm², A is the surface area of the coupon in cm², and t is the exposure time in hours.

The method comprises adding the quaternary siloxane compound or the corrosion-inhibiting composition comprising the quaternary siloxane compound in a corrosive inhibiting effective amount. The dosage amounts of the compositions described herein to be added to oil-field system or water system can be tailored by one skilled in the art based on factors for each system, including, for example, content of fluid, volume of the fluid, surface area of the system, temperatures, pH, and CO₂ content. In embodiments, an effective amount of the composition is from about 1 ppm to about 5,000 ppm. In embodiments, an effective amount is from about 1 ppm to about 5,000 ppm, from about 5 ppm to about 1,000 ppm, or preferably from about 5 ppm to about 500 ppm, based on the total volume of the system.

The oil-field systems include oil or gas pipelines and refineries, including for example, well, pipeline, fuel storage and/or transportation tanks, fuel distribution system. Containments and pipelines can also include those in the production, transportation, storage and/or separation of crude oil, natural gas or a biofuel process.

The water systems include processes or transportation lines, including various types of water systems, e.g., cooling water, geothermal processes, nuclear water cooling, water desalination, wastewater treatment, etc.

The system includes a fluid to which the composition is added. A fluid to which the compositions can be introduced can be a hydrocarbon fluid or gas, produced water, or combination thereof. As referred to herein, hydrocarbon fluid comprises crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof. In many embodiments, hydrocarbon fluids comprise refined hydrocarbon product. The liquid can also be a heavy brine.

The fluid can be contained in and/or exposed to many different types of apparatuses. In embodiments, the fluid is contained in a containment, such as an oil or gas pipeline or a water system. Additionally, the fluid can be contained in refineries, such as surfaces used in the recovery, transportation, refining and/or storage of hydrocarbon fluids or gases or various types of water processing and/or transportation.

The oil-field systems or water systems comprise a surface in need of corrosion inhibition. Exemplary surfaces can include separation vessels, dehydration units, gas lines, oil and/or gas pipelines, or other part of an oil and/or gas refinery or any type of water processing or transportation. Similarly, the fluid can be contained in and/or exposed to an apparatus used in oil extraction and/or production, such as a wellhead. The apparatus can be part of a coal-fired power plant. The apparatus can be a scrubber (e.g., a wet flue gas desulfurizer, a spray dry absorber, a dry sorbent injector, a spray tower, a contact or bubble tower, or the like). The apparatus can be a cargo vessel, a storage vessel, a holding tank, or a pipeline connecting the tanks, vessels, or processing units.

The system comprises a metal surface subject to corrosion. In embodiments the surfaces can include a variety of metal surfaces that are subject to corrosion. The metals can comprise a component selected from the group consisting of mild steel, galvanized steel, carbon steel, aluminum, aluminum alloys, copper, copper nickel alloys, copper zinc alloys, brass, chrome steels, ferritic alloy steels, austenitic stainless steels, precipitation-hardened stainless steels, high nickel content steels, and any combination thereof.

The compositions are applied to fluids in an oil-field system or water system at varying pH ranges. In an embodiment the pH of the fluids will be between about 2 and about 8.

The compositions can be applied to a fluid in an oil-field system or a water system at any selected temperature, such as ambient temperature or an elevated temperature. The fluid (e.g., liquid hydrocarbon) can be at a temperature of from about 0° C. to about 100° C.

The compositions can be applied by any appropriate method for ensuring dispersal through the fluid. The compositions can be applied to a fluid using various well-known methods and they can be applied at numerous different locations throughout a given system. For example, the compositions can be injected using mechanical equipment such as chemical injection pumps, piping tees, injection fittings, atomizers, quills, and the like. The compositions can be pumped into an oil and/or gas pipeline using an umbilical line. A capillary injection system can be used to deliver the compounds/compositions to a selected fluid.

The compositions can be added to the system manually or automatically in either a batch or continuous manner to provide the effective amount of the corrosion-inhibiting composition. In some embodiments, the compositions are added to a flow line to provide a corrosive inhibiting effective amount from about 1 to about 5,000 parts per million (ppm), from about 5 to about 1,000 parts per million (ppm), or from about 5 to about 500 parts per million (ppm), based on the total volume of the system. In some embodiments, the compositions are added to a flow line to provide a corrosive inhibiting effective amount from at least about 1 ppm, 2 ppm, 5 ppm, 10 ppm, 20 ppm, 50 ppm, 100 ppm, 200 ppm, 250 ppm, or 500 ppm based on the total volume of the system. Each system can have its own dose level requirements, and the effective dose level of the composition to sufficiently reduce the rate of corrosion can vary with the system in which it is used.

The compositions can be added to the system by any suitable means, including for example by injecting the composition into a fluid or gas in contact with the metal surface, pumping the composition onto the metal surface, pouring the composition onto the metal surface, spraying the composition onto the metal surface, wiping the metal surface with the composition, coating the metal surface with the composition, dipping the metal surface in the composition, soaking the metal surface in the composition, or any combination thereof.

### EMBODIMENTS

The present disclosure is further defined by the following numbered embodiments:

1. A corrosion-inhibiting composition comprising: a quaternary siloxane compound having the general formula:

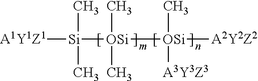

wherein:
Z¹, Z², and Z³ are independently N⁺R⁴R⁵R⁶X⁻ or absent, wherein: R⁴ and R⁵ are independently C1-20 alkyl or hydroxyalkyl groups, and R⁶ is a C1-20 alkyl, aminoalkyl, hydroxyalkyl, or amino hydroxyalkyl group; X⁻ is an anion, such as fluoride, chloride, bromide, iodide, nitrate, or nitrite;
Y¹, Y² and, Y³ are independently C1-20 alkyl, hydroxyalkyl, or absent;
A¹, A², and A³ are independently a Si(CH₃)₃, an OSi(CH₃)₃, a methyl or (CH₂)ₚ—O, wherein p is from 1 to 100;
m is from 1 to 2,000; an
n is 1 to 150, and
a solvent, and
at least one additional component selected from the group consisting of additional corrosion inhibitors, surfactants, polymers, pH modifiers, asphaltene inhibitors, paraffin inhibitors, scale inhibitors, metal complexing agents, emulsifiers, water clarifiers, dispersants, emulsion breakers and combinations thereof.

2. The composition of embodiment 1, wherein the corrosion inhibition composition has at least two quaternary groups and is thermostable.

3. The composition of any one of embodiments 1-2, wherein the quaternary siloxane compound has one of the following structures:

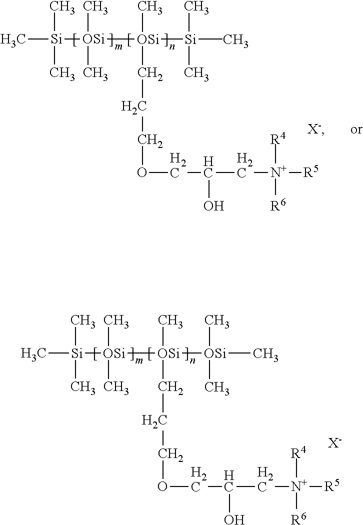

wherein:
R⁴, R⁵, and R⁶ are independently C1-20 alkyl or hydroxyalkyl groups;
X⁻ is an anion;
m is from 1 to 2,000; and
n is 1 to 150.

4. The composition of embodiment 3, wherein the quaternary siloxane compound has one of the following structures:

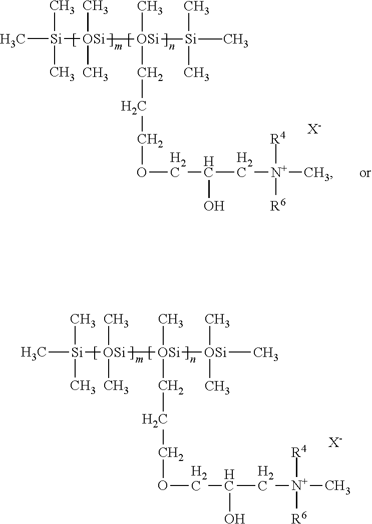

wherein:
R⁴ and R⁶ are independently C1-20 alkyl or hydroxyalkyl groups;
X⁻ is an anion;
m is from 1 to 2,000; and
n is 1 to 150.

5. The composition of any one of embodiments 1-2, wherein the quaternary siloxane compound is a silicone dialkyl quaternary compound.

6. The composition of embodiment 5, wherein the silicone dialkyl quaternary compound has the general structure:

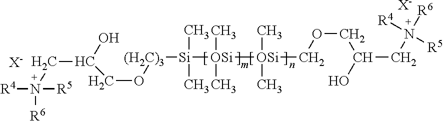

wherein:
R⁴, R⁵, and R⁶ are independently C1-20 alkyl or hydroxyalkyl groups;
X⁻ is an anion;
m is from 1 to 2,000; and
n is 1 to 150.

7. The composition of embodiment 6, wherein the silicone dialkyl quaternary compound has the general structure:

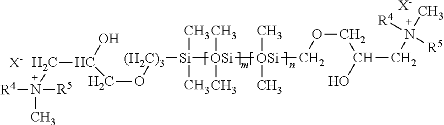

wherein:
R⁴ and R⁵ are independently C1-20 alkyl or hydroxyalkyl groups;
X⁻ is an anion;
m is from 1 to 2,000; and
n is 1 to 150.

8. The composition of any one of embodiments 1-2, wherein the quaternary siloxane compound is a silicone polyether fatty quaternary compound.

9. The composition of embodiment 8, wherein the silicone polyether fatty quaternary compound has one of the general structures:

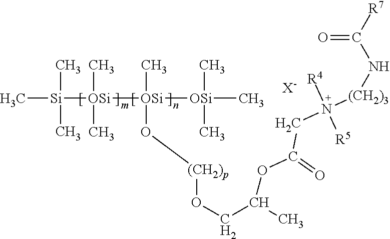

wherein:
R⁴ and R⁵ are independently C1-20 alkyl or hydroxyalkyl groups;
R⁷ is a C1-20 alkyl or hydroxyalkyl group;
X⁻ is an anion;
m is from 1 to 2,000;
n is 1 to 150; and
o is 1 to 100, or

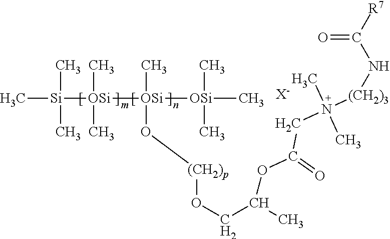

wherein:
R⁷ is independently C1-20 alkyl or hydroxyalkyl groups;
X⁻ is an anion;
m is from 1 to 2,000;
n is 1 to 150; and
o is 1 to 100.

10. The composition of any one of embodiments 1-9, wherein the quaternary siloxane compound has at least about 2% to about 80% Si and/or the ratio of the molecular weights of the silicone/siloxane groups to the quaternary ammonium groups in the quaternary siloxane compound is greater than about 1.5:1.

11. The composition of any one of embodiments 1-10, wherein the at least one additional component comprises an imidazoline compound, a pyridinium compound, a quaternary ammonium compound, a phosphate ester, an amine, an amide, a carboxylic acid, a thiol, or any combination thereof.

12. The composition of any one of embodiments 1-11, wherein the quaternary siloxane compound comprises from about 5 wt-% to about 80 wt-% of the composition.

13. The composition of any one of embodiments 1-12, wherein the corrosion inhibition composition is substantially free of thiazine quaternary ammonium compounds and silated quaternary ammonium compounds (e.g. quaternary organosilanes).

14. A method of controlling corrosion on a surface comprising: providing a corrosive inhibiting effective amount of a corrosion inhibition composition according to any one of embodiments 1-13 into contact with a surface comprising metal and is in an oil-and-gas system or waste system, and wherein the contacting is added in a batch or continuous application, and reducing corrosion on the surface.

15. The method of embodiment 14, wherein the corrosive inhibiting effective amount of the composition is from about 1 ppm to about 5,000 ppm, about 5 ppm to about 1,000 ppm, or about 5 ppm to about 500 ppm, based on the total volume of the system.

16. The method of any one of embodiments 14-15, wherein the metal surface comprises steel.

17. The method of embodiment 15, wherein the surface is a containment used in the production, transportation, storage and/or separation of crude oil, natural gas or a biofuel process, or a water system process or transportation line.

18. The method of any one of embodiments 14-17, wherein the system comprises a hydrocarbon fluid or gas, produced water, wastewater, cooling water, or combination thereof.

19. The method of any one of embodiments 14-17, wherein the water system is a water process and/or water transportation line.

20. A treated metal containment comprising: a metal containment comprising a metal surface; and a barrier or film substantially coating the metal surface with a corrosive inhibiting effective amount of the quaternary siloxane compound having the general formula:

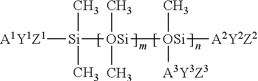

wherein:
Z¹, Z², and Z³ are independently N⁺R⁴R⁵R⁶X⁻ or absent, wherein: R⁴ and R⁵ are independently C1-20 alkyl or hydroxyalkyl groups, and R⁶ is a C1-20 alkyl, aminoalkyl, hydroxyalkyl, or amino hydroxyalkyl group; X⁻ is an anion;
Y¹, Y² and, Y³ are independently C1-20 alkyl, hydroxyalkyl, or absent;
A¹, A², and A³ are independently a Si(CH₃)₃, an OSi(CH₃)₃, a methyl or (CH₂)ₚ—O, wherein p is from 1 to 100;
m is from 1 to 2,000; and
n is 1 to 150.

21. The treated metal containment of embodiment 20, wherein the corrosive inhibiting effective amount of the quaternary siloxane compound is from about 1 ppm to about 5000 ppm, based on the total volume of the system.

22. The treated metal containment of any one of embodiments 20-21, wherein the metal surface comprises steel.

23. The treated metal containment of any one of embodiments 20-22, wherein the surface is a containment used in the production, transportation, storage and/or separation of crude oil, natural gas or a biofuel process, or a water system process or transportation line.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

Examples were conducted to identify alternatives to conventional dimethyl benzyl ammonium chloride corrosion inhibitor using bubble cell tests to assess corrosion performance using linear polarization resistance testing.

Quaternary siloxane compound corrosion inhibitors were evaluated for corrosion performance as compared to the benzyl quat in compositions at equal wt-% corrosion inhibitor with the sulfur-containing species 2-mercaptoethanol and solvent, as well as compared to a blank test, via a bubble test procedure. The evaluated chemistries are summarized in Table 1.

TABLE 1

| | | | | | 2-Mercapto- | Candidate | Corrosion | |
|---|---|---|---|---|---|---|---|---|
| | | 2-Mercapto- | Candidate | | ethanol | Chemistry | Rate After | |
| | | ethanol | Chemistry | | Active | Active | 15 h of Cl | |
| Candidate | | Activity | Activity | Dosage | Injected in | Injected in | Injection | % |
| Chemistry | | (%) | (%) | (ppm) | Test (ppm) | Test (ppm) | (mpy) | Protection |
| | | N/A | N/A | N/A | N/A | N/A | 502 | N/A |
| | Dimethyl benzyl ammonium | 1 | 10 | 20 | 0.2 | 2 | 353 | 30 |
| | chloride | | | | | | | |
| Silquat Di-25 | Linear, R = 2, % Si = 50-60% | 1 | 10 | 20 | 0.2 | 2 | 141 | 72 |
| Silquat J208-1B | Multi, R = 18, % Si = 15-25% | 1 | 10 | 20 | 0.2 | 2 | 114 | 77 |
| Silquat CR4000 | Multi, R = 2, % Si = 30-35% | 1 | 10 | 20 | 0.2 | 2 | 83 | 83 |
| Silquat AD | Multifunctional, R = 18, | 1 | 10 | 20 | 0.2 | 2 | 132 | 74 |
| | % Si = 8-12% | | | | | | | |
| Silquat AC | Multi, R = 12, % Si = 5-10% | 1 | 10 | 20 | 0.2 | 2 | 156 | 69 |
| Silquat J15 | Multi, R = 2, % Si = 55-65% | 1 | 10 | 20 | 0.2 | 2 | 145 | 71 |
| Silquat Di-10 | Linear, R = 2, % Si = 45-55% | 1 | 10 | 20 | 0.2 | 2 | 92 | 82 |
| Silquat J2-2B | Multi, R = 2, 18, % Si = 25-35% | 1 | 10 | 20 | 0.2 | 2 | 142 | 72 |
| Silquat J2-8B | Multi, R = 2, 18, % Si = 15-25% | 1 | 10 | 20 | 0.2 | 2 | 130 | 74 |
| Silquat C18 | Mono, R = 18, % Si = approx 10% | 1 | 10 | 20 | 0.2 | 2 | 82 | 84 |
| | as SiO2 | | | | | | | |

The bubble test simulates low flow areas where little or no mixing of water and oil occurs. The test was conducted using brine (80% of the brine being 3% sodium chloride brine and 20% of the brine being a hydrocarbon containing LVT-200. The brine was placed into kettles and purged with carbon dioxide. The brine was continually purged with carbon dioxide at 1 bar CO₂ to saturate the brine prior to starting the test for a 3-4 hour pre-corrode (i.e. before any corrosion inhibitor added). After the test began, the test cell was blanketed with carbon dioxide one hour prior to electrode insertion and through the duration of the test to maintain saturation. The kettles were stirred at 100 revolutions per minute (rpm) for the duration of the test to maintain thermal equilibrium at 80° C.

The corrosion rate was measured by Linear Polarization Resistance (LPR) techniques. The working electrode used was carbon steel. The counter and reference electrodes were both 1018 carbon steel. The electrodes were all cleaned and polished prior to testing. Data were collected for 3-4 hours before 20 ppm of each of the compositions was dosed into its respective cell (10% active quaternary siloxane compound, with 1% 2-mercaptoethanol in solvent blend), resulting in 2 ppm of active chemistry with 0.2 ppm 2-mercaptoethanol introduced into the test cell. Data were collected overnight for 15 hour test duration.

The results of the bubble test are summarized in Table 1 where the corrosion rates are measured in mpy over the 15 hour test duration. The results show corrosion rates of the evaluated compositions compared to the dimethyl benzyl ammonium chloride corrosion inhibitor. The reference to ppm is parts per million, CI is corrosion inhibitor, and mpy is mils per year referring to the corrosion rate.

The inhibited corrosion rate at about 15 hours after CI chemical injection was noted and a percentage inhibition determined by comparing with the corrosion rate of a carbon steel electrode under otherwise the same conditions in the absence of chemical corrosion inhibitor after the same time of exposure to the corrosive environment. The evaluated levels used low concentration as an intentional differentiator between the chemistries. The evaluated quaternary siloxane compound corrosion inhibitors all substantially outperformed the dimethyl benzyl ammonium chloride corrosion inhibitor.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A corrosion-inhibiting composition comprising:
a quaternary siloxane compound having the general formula: 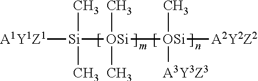
wherein:
Z¹, Z², and Z³ are independently N⁺R⁴R⁵R⁶X⁻ or absent, wherein: R⁴ and R⁵ are independently C1-20 alkyl or hydroxyalkyl groups, and R⁶ is a C1-20 alkyl, aminoalkyl, hydroxyalkyl, or amino hydroxyalkyl group; X⁻ is an anion, such as fluoride, chloride, bromide, iodide, nitrate, or nitrite;
Y¹, Y² and, Y³ are independently C1-20 alkyl, hydroxyalkyl, or absent;
A¹, A², and A³ are independently a Si(CH₃)₃, an OSi(CH₃)₃, a methyl or (CH₂)ₚ—O, wherein p is from 1 to 100;
m is from 1 to 2,000; and
n is 1 to 150, and
a solvent, and
at least one additional component selected from the group consisting of additional corrosion inhibitors, surfactants, polymers, pH modifiers, asphaltene inhibitors, paraffin inhibitors, scale inhibitors, metal complexing agents, emulsifiers, water clarifiers, dispersants, emulsion breakers and combinations thereof.

2. The composition of claim 1, wherein the corrosion inhibition composition has at least two quaternary groups and is thermostable.

3. The composition of claim 1, wherein the quaternary siloxane compound has one of the following structures: 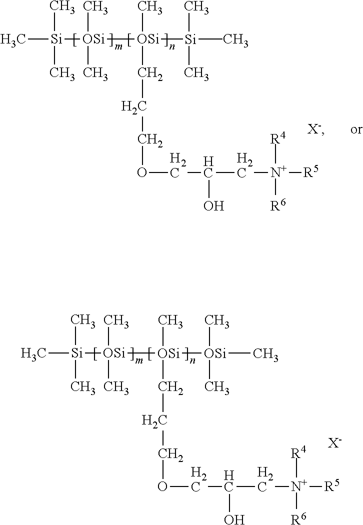
wherein:
R⁴, R⁵, and R⁶ are independently C1-20 alkyl or hydroxyalkyl groups;
X⁻ is an anion;
m is from 1 to 2,000; and
n is 1 to 150.

4. The composition of claim 3, wherein the quaternary siloxane compound has one of the following structures: 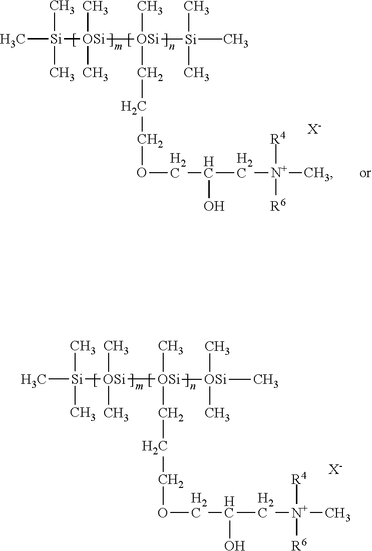
wherein:
R⁴ and R⁶ are independently C1-20 alkyl or hydroxyalkyl groups;
X⁻ is an anion;
m is from 1 to 2,000; and
n is 1 to 150.

5. The composition of claim 1, wherein the quaternary siloxane compound is a silicone dialkyl quaternary compound.

6. The composition of claim 5, wherein the silicone dialkyl quaternary compound has the general structure: 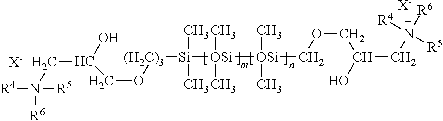
wherein:
R⁴, R⁵, and R⁶ are independently C1-20 alkyl or hydroxyalkyl groups;
X⁻ is an anion;
m is from 1 to 2,000; and
n is 1 to 150.

7. The composition of claim 6, wherein the silicone dialkyl quaternary compound has the general structure: 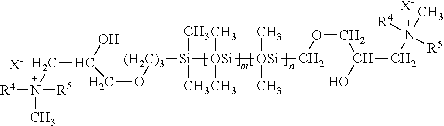
wherein:
R⁴ and R⁵ are independently C1-20 alkyl or hydroxyalkyl groups;
X⁻ is an anion;
m is from 1 to 2,000; and
n is 1 to 150.

8. The composition of claim 1, wherein the quaternary siloxane compound is a silicone polyether fatty quaternary compound.

9. The composition of claim 8, wherein the silicone polyether fatty quaternary compound has one of the general structures: 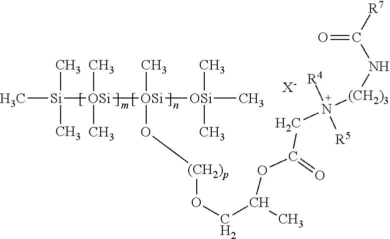
wherein:
R⁴ and R⁵ are independently C1-20 alkyl or hydroxyalkyl groups;
R⁷ is a C1-20 alkyl or hydroxyalkyl group;
X⁻ is an anion;
m is from 1 to 2,000;
n is 1 to 150; and
o is 1 to 100, or 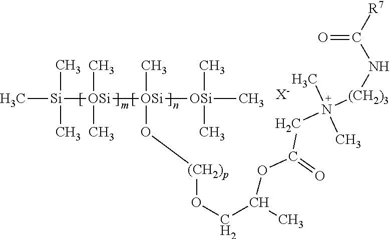
wherein:
R⁷ is independently C1-20 alkyl or hydroxyalkyl groups;
X⁻ is an anion;
m is from 1 to 2,000;
n is 1 to 150; and
o is 1 to 100.

10. The composition of claim 1, wherein the quaternary siloxane compound has at least about 2% to about 80% Si (based on wt-% of the compound) and/or the ratio of the molecular weights of the silicone/siloxane groups to the quaternary ammonium groups in the quaternary siloxane compound is greater than about 1.5:1.

11. The composition of claim 1, wherein the at least one additional component comprises an imidazoline compound, a pyridinium compound, a quaternary ammonium compound, a phosphate ester, an amine, an amide, a carboxylic acid, a thiol, or any combination thereof.

12. The composition of claim 1, wherein the quaternary siloxane compound comprises from about 5 wt-% to about 80 wt-% of the composition.

13. The composition of claim 1, wherein the corrosion inhibition composition is substantially free of thiazine quaternary ammonium compounds and silated quaternary ammonium compounds.

14. A method of controlling corrosion on a surface comprising:
providing a corrosive inhibiting effective amount of a corrosion inhibition composition according to claim 1 into contact with a surface comprising metal and is in an oil-and-gas system or waste system, and wherein the contacting is added in a batch or continuous application, and
reducing corrosion on the surface.

15. The method of claim 14, wherein the corrosive inhibiting effective amount of the composition is from about 1 ppm to about 5,000 ppm, based on the total volume of the system, and wherein the metal surface comprises steel.

16. The method of claim 15, wherein the surface is a containment used in the production, transportation, storage and/or separation of crude oil, natural gas or a biofuel process, or a water system process or transportation line.

17. The method of claim 14, wherein the system comprises a hydrocarbon fluid or gas, produced water, wastewater, cooling water, or combination thereof.

18. The method of claim 16, wherein the water system is a water process and/or water transportation line.

19. A treated metal containment comprising:
a metal containment comprising a metal surface; and
a barrier or film substantially coating the metal surface with a corrosive inhibiting effective amount of the quaternary siloxane compound having the general formula: 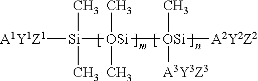
wherein:
Z¹, Z², and Z³ are independently N⁺R⁴R⁵R⁶X⁻ or absent, wherein: R⁴ and R⁵ are independently C1-20 alkyl or hydroxyalkyl groups, and R⁶ is a C1-20 alkyl, aminoalkyl, hydroxyalkyl, or amino hydroxyalkyl group; X⁻ is an anion;
Y¹, Y² and, Y³ are independently C1-20 alkyl, hydroxyalkyl, or absent;
A¹, A², and A³ are independently a Si(CH₃)₃, an OSi(CH₃)₃, a methyl or (CH₂)ₚ—O, wherein p is from 1 to 100;
m is from 1 to 2,000; and
n is 1 to 150.

20. The treated metal containment of claim 19, wherein the corrosive inhibiting effective amount of the quaternary siloxane compound is from about 1 ppm to about 5000 ppm, based on the total volume of the system, and wherein the metal surface comprises steel.

21. The treated metal containment of claim 20, wherein the surface is a containment used in the production, transportation, storage and/or separation of crude oil, natural gas or a biofuel process, or a water system process or transportation line.
